(19) United States
(12) Patent Application Publication
(10) Pub. No.: US 2013/0230642 A1
(43) Pub. Date: Sep. 5, 2013

(54) METHOD OF MANUFACTURING ACTIVE RETARDER AND METHOD OF MANUFACTURING DISPLAY APPARATUS HAVING THE SAME

(71) Applicant: SAMSUNG DISPLAY CO., LTD., Yongin-City (KR)

(72) Inventors: HeeWook DO, Cheonan-si (KR); Sang-Jae Kim, Seongnam-si (KR); Soyoun Park, Suwon-si (KR); Hoyun Byun, Osan-si (KR); Duck Jong Suh, Seoul (KR); SangHee Yu, Yongin-si (KR); SangGu Lee, Seoul (KR); Ji-Yoon Jung, Bucheon-si (KR); MinOh Choi, Cheonan-si (KR)

(73) Assignee: Samsung Display Co., Ltd., Yongin-City (KR)

(21) Appl. No.: 13/783,802

(22) Filed: Mar. 4, 2013

(30) Foreign Application Priority Data
Mar. 5, 2012 (KR) 10-2012-0022396

(51) Int. Cl. G02F 1/1333

(52) U.S. Cl. CPC G02F 1/133305
USPC 427/98.4

(57) ABSTRACT

A method of manufacturing an active retarder includes forming a first substrate, forming a second substrate, and forming a liquid crystal layer between the first substrate and the second substrate. The forming of the first and second substrates is performed by a roll-to-roll process.

### CROSS-REFERENCE TO RELATED APPLICATION

This U.S. non-provisional patent application claims priority under 35 U.S.C. §119 to Korean Patent Application No. 10-2012-0022396, filed on Mar. 5, 2012, the disclosure of which is hereby incorporated by reference herein in its entirety.

### 1. TECHNICAL FIELD

The present disclosure relates to a method of manufacturing an active retarder and a method of manufacturing a display apparatus having the active retarder.

### 2. DISCUSSION OF THE RELATED ART

A three-dimensional (3D) image display apparatus may provide a left-eye image and a right-eye image, which have a binocular disparity, to left and right eyes of a user, respectively. The left- and right-eye images observed at different angles by two eyes of the user are transmitted to the human brain. The human brain may mix the inputs of the images with each other and perceive the 3D image.

The 3D image display apparatus using the binocular disparity is classified into, for example, two types, e.g., a glass-type method and a glassless-type method. The glass-type 3D image display apparatus may alternately display the left-eye image and the right-eye image and control polarization properties of the glasses to display the 3D image. The glassless-type 3D image display apparatus may allow the user to perceive different image information through the two eyes by, for example, disposing a lenticular lens and a parallax barrier at a position spaced apart from a two-dimensional display panel.

The glass-type 3D image display apparatus includes, for example, a display panel and an active retarder panel. The active retarder panel may have, for example, a structure similar to that of a liquid crystal panel that includes two glass substrates, on which transparent electrodes are respectively formed, and a liquid crystal layer disposed between the two glass substrates.

### SUMMARY

Exemplary embodiments of the present invention may provide a method of manufacturing an active retarder, capable of simplifying a manufacturing process of the active retarder.

Exemplary embodiments of the present invention may provide a method of manufacturing a display apparatus having the active retarder.

In accordance with an exemplary embodiment of the present invention, a method of manufacturing an active retarder for a display apparatus is provided. The method includes forming a first substrate, forming a second substrate, and forming a liquid crystal layer between the first substrate and the second substrate. The forming of the first and second substrates is performed by a roll-to-roll process.

In an embodiment, the forming of the first substrate includes preparing a first base film, forming a first transparent conductive material on the first base film, and patterning the first transparent conductive material to form a first electrode on the first base film.

In an embodiment, the forming of the second substrate includes preparing a second base film and forming a second transparent conductive material on the second base film to form a second electrode on the second base film.

In an embodiment, the first transparent conductive material and the second transparent conductive material are coated by a wet process, and the first transparent conductive material is patterned by a laser etching process.

In an embodiment, the forming of the liquid crystal layer includes forming a spacer on the first substrate, forming a sealant on the first substrate, dropping a liquid crystal on the first substrate, positioning the second substrate to face the first substrate, and curing the sealant.

In an embodiment, the spacer is formed by scattering beads on the first substrate or by a gravure printing method.

In an embodiment, a plurality of barrier layers are formed on an upper surface and a lower surface of the first base film and on an upper surface and a lower surface of the second base film, respectively.

In accordance with an exemplary embodiment of the present invention, a method of manufacturing a display apparatus is provided. The method includes preparing a display panel and attaching an active retarder manufactured by the above-mentioned method to the display panel. In an embodiment, the active retarder is attached on the display panel by attaching a release film on a surface of the active retarder while interposing an adhesive layer between the release film and the active retarder and removing the release film to attach the active retarder to the display panel.

In accordance with an exemplary embodiment of the present invention, a method of manufacturing an active retarder for a display apparatus is provided. The method includes forming a first flexible substrate. The forming of the first flexible substrate includes preparing a first base film, forming a first barrier layer on an upper surface of the first base film, forming a first electrode on the first barrier layer, and forming a first alignment layer on the first electrode.

The forming a second flexible substrate includes preparing a second base film, forming a second barrier layer on an upper surface of the second base film, forming a second electrode on the second barrier layer, forming a second alignment layer on the second electrode.

In addition, the method further includes attaching a first retardation film on an upper surface of the second barrier layer using a first adhesive layer provided on the upper surface of the second barrier layer, attaching a protective film onto an upper surface of the first retardation film using a second adhesive layer provided on the upper surface of the first retardation film, providing liquid crystals on one of the first flexible substrate or the second flexible substrate and attaching the first flexible substrate and the second flexible substrate to each other with a liquid crystal layer disposed therebetween.

According to an exemplary embodiment of the present invention, the manufacturing process for forming the active retarder and the display apparatus may be simplified, and thus the manufacturing cost and time for forming the active retarder may be reduced. In addition, as the flexible substrate formed of polymer instead of a glass substrate, the manufacturing cost for forming the active retarder and the display apparatus having the active retarder may in turn be reduced.

### BRIEF DESCRIPTION OF THE DRAWINGS

Exemplary embodiments of the present invention can be understood in more detail from the following detailed description taken in conjunction with the accompanying drawings wherein:

FIG. 1 is an exploded perspective view showing a display apparatus according to an exemplary embodiment of the present invention;

FIG. 2 is a cross-sectional view showing the display apparatus shown in FIG. 1;

FIG. 3 is a plan view showing an active retarder according to an exemplary embodiment of the present invention;

FIG. 4 is a cross-sectional view taken along a line I-I′ shown in FIG. 3;

FIG. 5 is a plan view showing an active retarder according to an exemplary embodiment of the present invention;

FIG. 6 is a cross-sectional view taken along a line II-IF shown in FIG. 5; and

FIG. 7 is a flowchart illustrating a method of manufacturing a display apparatus according to an exemplary embodiment of the present invention.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items. In the drawings, the thickness of layers, films, panels, regions, etc., may be exaggerated for clarity.

As used herein, the singular forms, “a”, “an”, and “the” are intended to include plural forms as well, unless the context clearly indicates otherwise.

As used herein, the singular forms, “a”, “an” and “the” are intended to include the plural forms as well, unless the context clearly indicates otherwise.

Hereinafter, exemplary embodiments of the present invention will be explained in detail with reference to the accompanying drawings.

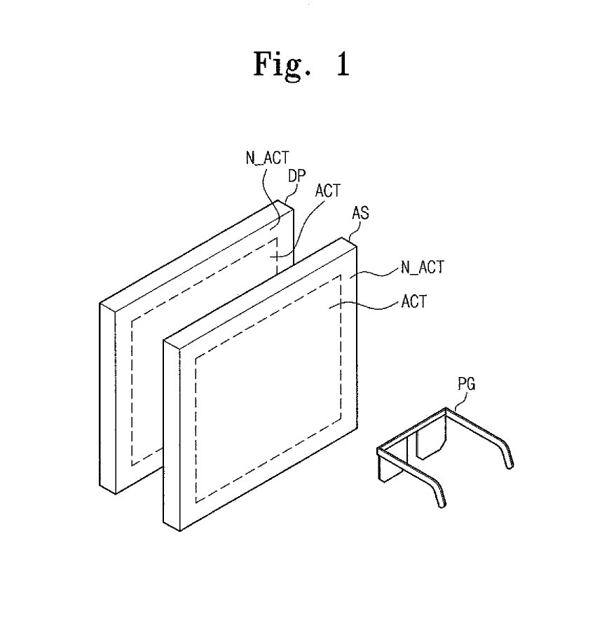

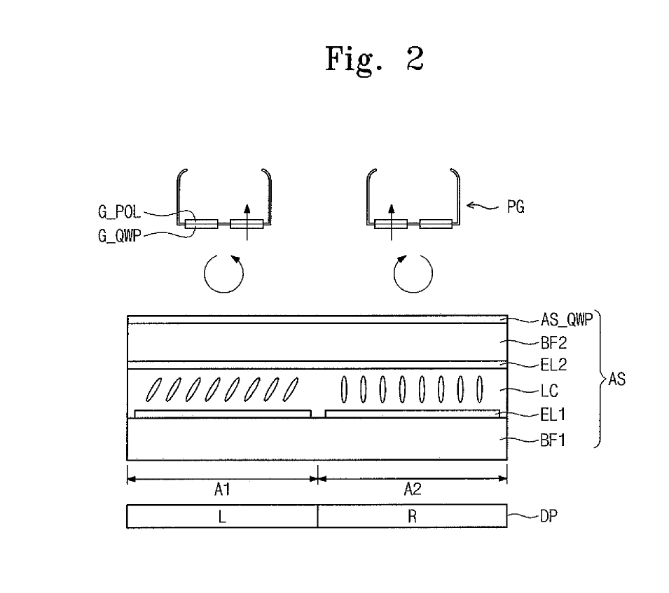

FIG. 1 is an exploded perspective view showing a display apparatus according to an exemplary embodiment of the present invention and FIG. 2 is a cross-sectional view showing the display apparatus shown in FIG. 1. In FIGS. 1 and 2, for explaining a principle of displaying a three-dimensional (3D) image, elements of the display apparatus have been schematically shown and partially omitted.

Referring to FIGS. 1 and 2, a display apparatus includes, for example, a display panel DP that displays a two-dimensional (2D) image, an active retarder AS disposed between the display panel DP and a user to separate the 2D image into a left-eye image and a right-eye image and provide the left-eye image and the right-eye image to the user, and a pair of polarizing glasses PG that selectively transmits the left-eye image and the right-eye image to allow the user to perceive the 3D image.

The display panel DP may be, but is not limited to, various display panels, such as a liquid crystal display panel, an electrophoretic display panel, an organic light emitting display panel, a plasma display panel, etc. As a representative example, the liquid crystal display panel will be described as the display panel in the present exemplary embodiment.

The display panel DP may have, for example, a rectangular shape with long sides and short sides and includes a display area ACT in which an image is displayed and a non-display area N_ACT except for the display area ACT. Although not shown in FIGS. 1 and 2, the display panel DP includes, for example, an array substrate, an opposite substrate facing the array substrate, and a liquid crystal layer interposed between the array substrate and the opposite substrate. The array substrate includes a plurality of data lines, a plurality of gate lines, and a plurality of pixels. The data lines are insulated from the gate lines while crossing the gate lines. The pixels are arranged on the array substrate in, for example, a matrix form. For example, the pixels include a first pixel part L configured to include pixels for the left-eye image and a second pixel part R configured to include pixels for the right-eye image. The first pixel part L and the second pixel part R are extended in a predetermined direction and alternately arranged with each other. For the convenience of explanation, one first pixel part L and one second pixel part R, which are adjacent to each other, have been shown in FIG. 2.

Each of the pixels includes, for example, a thin film transistor and a liquid crystal capacitor connected to the thin film transistor. The thin film transistor includes, for example, a gate electrode connected to a corresponding gate line of the gate lines, a source electrode connected to a corresponding data line of the data lines, and a drain electrode connected to the liquid crystal capacitor.

Meanwhile, the liquid crystal capacitor is formed by a pixel electrode disposed on the array substrate, a common electrode disposed on the opposite substrate to face the pixel electrode, and the liquid crystal layer interposed between the pixel electrode and the common electrode. For example, the common electrode is formed on the opposite substrate in a vertical electric field driving manner, such as a twisted nematic (TN) mode, a vertical alignment (VA) mode, but formed on the array substrate in a horizontal electric field driving manner, such as an in-plane switching (IPS) mode, a fringe field switching (FFS) mode, a plane to line switching (PLS) mode, together with the pixel electrode. The display panel DP includes, for example, a first polarizing plate and a second polarizing plate, which are respectively attached to the array substrate and the opposite substrate. The first polarizing plate has a light absorption axis which is, for example, substantially perpendicular to a light absorption axis of the second polarizing plate. In addition, the display panel DP may be, but is not limited to, a transmissive type liquid crystal display panel, a transflective type liquid crystal display panel, a reflective type liquid crystal display panel, etc.

The active retarder AS is disposed between the display panel DP and the user. For instance, the active retarder AS may be disposed on the display panel DP. The active retarder AS has an area corresponding to the display area ACT of the display panel DP which displays an image, and thus, hereinafter, this area of the active retarder AS will be referred to as the display area ACT and the area except for the display area ACT is referred to as the non-display area N_ACT.

The active retarder AS includes, for example, a first base film BF1 including a first electrode EL1 disposed thereon, a second base film BF2 including a second electrode EL2 disposed thereon and facing the first base film BF1, a liquid crystal layer LC disposed between the first electrode EL1 and the second electrode EL2, and a first retardation film AS_QWP provided on an outer surface of the second base film BF2, which faces the user, to delay a phase of light passing therethrough by about λ/4.

The active retarder AS includes, for example, a first area A1 corresponding to the first pixel part L and a second area A2 corresponding to the second pixel part R. The first electrode EL1 is provided, for example, in a plural number and the first electrodes EL1 are provided in each of the first area A1 and the second area A2. The second electrode EL2 is provided to cover the first area A1 and the second area A2 and applied with a reference voltage. The first area A1 and the second area A2 of the active retarder AS are turned on or off in accordance with the application of the voltage to the first and second areas A1 and A2, and thus the first and second areas A1 and A2 may be independently operated from each other. According to the turn-on or turn-off of the active retarder AS, a light passing through the first area A1 and a light passing through the second area A2 have different polarizing directions from each other. For instance, when the first area A1 of the active retarder AS is turned on and the second area A2 of the active retarder AS is turned off, the light passing through the first area A1 is, for example, linearly polarized at 90 degrees when compared with the light passing through the second area A2. That is, the linearly polarized light exits from the first area A1 in a vertical direction crossing a vertical direction in which the linearly polarized light exiting from the second area A2 travels. In this case, according to the application condition of the voltage to the first area A1 or the second area A2, the first and second areas A1 and A2 may have fixed transmission axes crossing each other or have variable transmission axes crossing each other every driving frame. The linearly polarized light of the first area A1 and the linearly polarized light of the second area A2 are turned to circularly polarized lights traveling in different directions by the first retardation film AS_QWP. Details of the active retarder AS are described below herein.

The pair of polarizing glasses PG includes, for example, a second retardation film G_QWP delaying a phase of light passing therethrough by about λ/4 and a polarizing film G_POL having different transmission axes from each other with respect to the left eye and the right eye. In the polarizing film G_POL, the left-eye polarizing film and the right-eye polarizing film may have, for example, transmission axes vertically crossing each other.

The second retardation film G_QWP turns the circularly polarized light to the linearly polarized light. Thus, the light linearly polarized for the left eye passes through the left-eye polarizing film and does not pass through the right-eye polarizing film, and the light linearly polarized for the right eye passes through the right-eye polarizing film and does not pass through the left-eye polarizing film. As a result, the user observes the left-eye image and the right-eye image through left and right eyes, respectively, and perceives the 3D image.

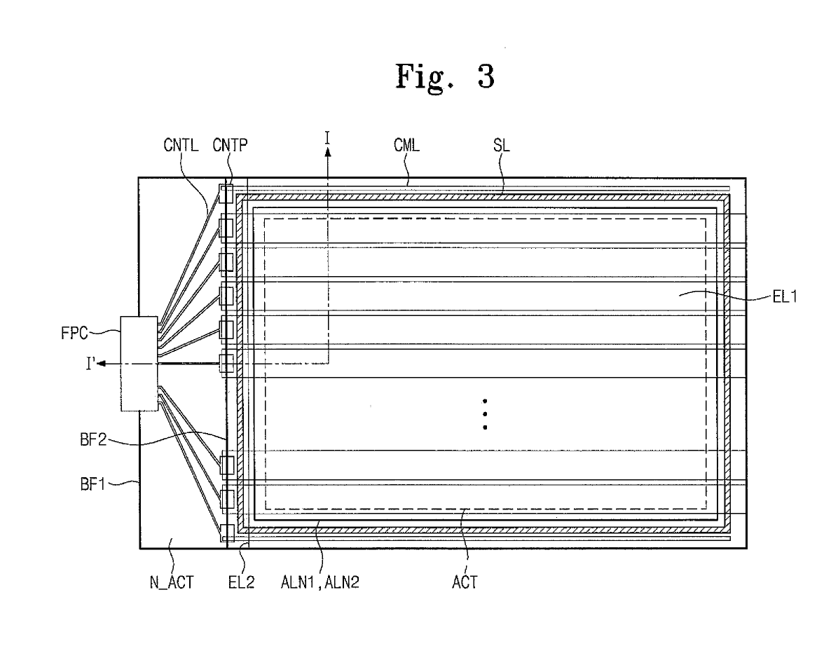

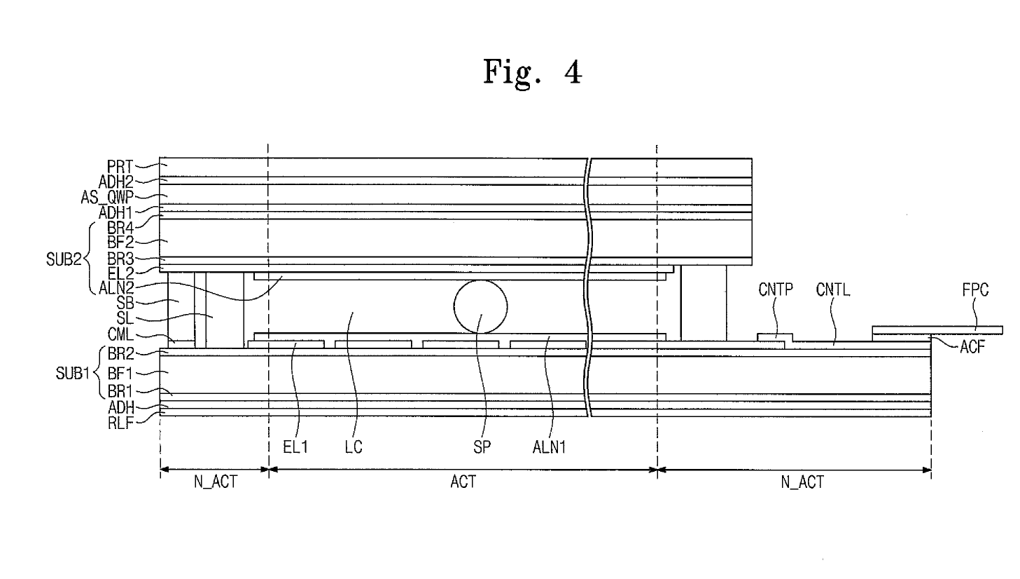

FIG. 3 is a plan view showing an active retarder according to an exemplary embodiment of the present invention FIG. 4 is a cross-sectional view taken along a line I-I′ shown in FIG. 3.

Hereinafter, for the convenience of explanation, a surface of each element, which faces the user, is referred to as an upper surface, and an opposite surface to the upper surface is referred to as a lower surface.

Referring to FIGS. 1 to 4, the active retarder AS includes, for example, a first substrate SUB1, a second substrate SUB2 facing the first substrate SUB1, a liquid crystal layer LC disposed between the first substrate SUB1 and the second substrate SUB2, and a sealing member SL disposed between the first substrate SUB1 and the second substrate SUB2 to seal the liquid crystal layer LC.

The first substrate SUB1 includes, for example, a first base film BF1, a first barrier layer BR1, a second barrier layer BR2, a first electrode EL1, and a first alignment layer ALN1.

The first base film BF1 has, for example, a rectangular shape with a pair of long sides and a pair of short sides to correspond to the shape of the display panel DP. The first base film BF1 has properties, such as, for example, transparency, flexibility, etc. To this end, the first base film BF1 may include, for example a cyclic olefin polymer (COP) and/or triacetyl cellulose (TAC) so as to have flexibility, but exemplary embodiments of the present invention are not limited thereto or thereby. For example, the first base film BF1 may include, for example, at least one of polyethylene terephthalate, polycarbonate, polyetheretherketone, polyester, polyethylene naphthalate, polyethersulfone, polyimide, polyarylate, or polynorbornene. The polymer used to form the first base film BF1 may have a glass transition temperature (Tg) of, for example, equal to or less than about 200 degrees Celsius. For example, the polymer used to form the first base film BF1 may have a glass transition temperature (Tg) of equal to or less than about 160 degrees Celsius.

The first barrier layer BR1 and the second barrier layer BR2 are disposed, for example, on both surfaces of the first base film BF1, respectively. That is, the first barrier layer BR1 is disposed on the lower surface of the first base film BF1 and the second barrier layer BR2 is disposed on the upper surface of the first base film BF1. In the present exemplary embodiment, the first and second barrier layers BR1 and BR2 are respectively disposed on both the upper and lower surfaces of the first base film BF1, but exemplary embodiments of the present invention arenot limited thereto or thereby. That is, alternatively, one of the first and second barrier layers BR1 and BR2 may be, for example, disposed only on the upper surface of the first base film BF1. The first and second barrier layers BR1 and BR2 may be formed of, for example, an acrylic-based polymer, e.g. polyacrylate. The first and second barrier layers BR1 and 13R2 protects the first base film BF1 from being damaged by processes of forming various layers formed on the first base film BF1. For instance, the first and second barrier layers BR1 and BR2 may have a chemical resistance with respect to a solvent used to form the first alignment layer ALN1, such as acetone, gammabutyrolacetone (GBL), N-methylpyrrolidone (NMP), butylcellosolve (BC), isopropylalcohol (IPA), N-ethylpyrrolidone, N-vinylpyrrolidone, N,N-dimethylacetamide, N,N-dimethylformamide, ethylcellosolve, ethylcarbitol, butylcarbitol (BC), ethylcarbitol acetate, ethylene glycol, propylene glycol monoacetate, propylene glycol diacetate, dipropylene glycol, and dipropylene glycol monomethyl ether.

The first electrode EL1 is disposed on the second barrier layer BR2. The first electrode EL1 may be made of, for example, a transparent material having a surface resistance of 100 Ω/sq or less. For example, the first electrode EL1 may be formed of a transparent conductive material such as, indium tin oxide (ITO), indium zinc oxide (IZO), silver nanowire (AgNW), aluminum-doped zinc oxide (AZO), gallium-doped zinc oxide (GZO), fluorine-doped tin oxide (FTO), antimony-doped tin oxide (ATO), cadmium tin oxide (CTO), zirconium oxide (ZrO₂), zinc oxide (ZnO) and combinations thereof. The first electrode EL1 is provided in, for example, a plural number and the first electrodes EL1 are arranged in the display area ACT. The first electrodes EL1 are insulated from and spaced apart from each other. Each first electrode EL1 has a ratio of, for example, 1:n (n is a constant number equal to or greater than 2) with respect to the gate lines disposed on the display panel DP.

Meanwhile, two first electrodes EL1 adjacent to each other are spaced apart from each other at a distance of, for example, about 5 micrometers. When the distance between the two adjacent first electrodes EL1 is greater than 5 micrometers, the area between the two adjacent first electrodes EL1 may be recognized by the user. The first electrode EL1 alternately corresponds to the first pixel part L and the second pixel part R. The first electrode EL1 is extended, for example, in a direction in which the first pixel part L and the second pixel part R are extended. In addition, the first electrode EL1 is extended onto the non-display area N_ACT to be connected a connection line CNTL that will be described later.

The first alignment layer ALN1 is disposed on the first electrode EL1 to align liquid crystal molecules of the liquid crystal layer LC. The first alignment layer ALN1 may include, for example, a polymer such as, an organic polymer, e.g., polyimide. Other possible polymers which may be used to form the first alignment layer ALN1 include, for example, organic polymers such as polyamide, polyamide-imide, polyvinyl alcohol, epoxyacrylate, spiranacrylate, and polyurethane.

The polymer may be, but is not limited to, a material having a glass transition temperature (Tg) equal to or less than about 200 degrees Celsius. For example, the polymer may have a glass transition temperature (Tg) equal to or less than about 160 degrees Celsius.

The first alignment layer ALN1 is provided to have a pre-tilt angle of, for example, about 5 degrees. A wire part is disposed on the first substrate SUB1 to apply a voltage to the first electrode EL1 and the second electrode EL2. The wire part is disposed in a portion of the non-display area N_ACT. The wire part includes, for example, a flexible printed circuit board FPC transmitting a driving signal of the active retarder AS from a controller (not shown), a connection line CNTL connected to the flexible printed circuit board FPC through an anisotropic conductive film ACF, a common line CML connected to the connection line CNTL to apply a reference voltage to the second electrode EL2, and a contact pad CNTP connected to the connection line CNTL and directly making contact with the first electrode EL1 and the common line CML. Alternatively, for example, in an embodiment, anisotropic paste ACP or other anisotropic conductive adhesives ACA may be used in place of the anisotropic conductive film ACF. The flexible printed circuit board FPC is disposed to correspond to one of the long sides or one of the short sides of the first base film BF1 and has, for example, a length shorter than a length of the corresponding side of the first base film BF1. Therefore, the connection line CNTL includes, for example, a fan-out part connected to between the flexible printed circuit board FPC and the first electrode EL1 and between the flexible printed circuit board FPC and the common line CML. The common line CML is provided in the non-display area N_ACT along one or more of the long sides and the short sides.

Meanwhile, for example, an adhesive layer ADH is disposed on the lower surface of the first substrate SUB1 and a release film RLF is attached to the lower surface of the first substrate SUB1 with the adhesive layer ADH disposed between the first substrate SUB1 and the release film RLF. When the active retarder AS is disposed on the display panel DP, the adhesive layer ADH adheres the active retarder AS to the display panel DP, and the release film RLF is removed.

The second substrate SUB2 includes, for example, a second base film BF2, a third barrier layer BR3, a fourth barrier layer BR4, a second electrode EL2, a second alignment layer ALN2, and the first retardation film AS_QWP.

The second base film BF2 has, for example, a rectangular shape with a pair of long sides and a pair of short sides to correspond to the shape of the display panel DP. The second base film BF2 is, for example, smaller in size than the first base film BF1, and thus a portion of the upper surface corresponding to the non-display area N_ACT of the first base film BF1, in which the wire part is formed, is exposed.

The second base film BF2 has properties, such as, for example, transparency, flexibility, etc. To this end, the second base film BF2 may include a cyclic olefin polymer (COP) and/or triacetyl cellulose (TAC) so as to have the flexibility, but exemplary embodiments of the present invention are not limited thereto or thereby. For instance, the second base film BF2 may include at least one of polyethylene terephthalate, polycarbonate, polyetheretherketone, polyester, polyethylene naphthalate, polyethersulfone, polyimide, polyarylate, or polynorbornene.

The polymer used to form the second base film BF2 may have a glass transition temperature (Tg) of, for example, equal to or less than about 200 degrees Celsius. For example, the polymer may have a glass transition temperature (Tg) of equal to or less than about 160 degrees Celsius.

The third barrier layer BR3 and the fourth barrier layer BR4 are disposed, for example, on both surfaces of the second base film BF2, respectively. That is, for example, the third barrier layer BR3 is disposed on the lower surface of the second base film BF2 and the fourth barrier layer BR4 is disposed on the upper surface of the second base film BF2. In the present exemplary embodiment, the third and fourth barrier layers BR3 and BR4 are respectively disposed on both the upper and lower surfaces of the second base film BF2, but exemplary embodiments of the present invention are not limited thereto or thereby. Alternatively, for example, one of the third and fourth barrier layers BR3 and BR4 may be disposed only on the upper surface of the second base film BF2 according to an embodiment. The second and fourth barrier layers BR3 and BR4 may be formed of, for example, an acrylic-based polymer. The third and fourth barrier layers BR3 and BR4 may protect the second base film BF2 from being damaged by processes of forming various layers formed on the second base film BF2. For instance, the third and fourth barrier layers BR3 and BR4 may have a chemical resistance with respect to solvent used to form the second alignment layer ALN2.

The second electrode EL2 is disposed on the third barrier layer BR3. The second electrode EL2 may be made of, for example, a transparent material. For example, the second electrode EL2 may be formed of a transparent material such as, indium tin oxide (ITO), indium zinc oxide (IZO), silver nanowire (AgNW), aluminum-doped zinc oxide (AZO), gallium-doped zinc oxide (GZO), fluorine-doped tin oxide (FTO), antimony-doped tin oxide (ATO), cadmium tin oxide (CTO), zirconium oxide (ZrO₂), zinc oxide (ZnO) and combinations thereof. The second electrode EL2 is provided in, for example, a single, e.g., a single plate-like shape, to cover the first pixel part L and the second pixel part R. In a portion of the second electrode EL2 corresponding to the side at which the flexible printed circuit board FPC and the fan-out part are provided, a position of an edge of the second electrode EL2 does not correspond to that of the first base film BF1. That is, for example, the edge of the second electrode EL2 is positioned inside the sealing member SL. Thus, the second electrode EL2 may be prevented from being shorted with the contact pad or the connection line CNTL.

The second electrode EL2 is electrically connected to the common line CML. Further, a shorting bar SB is formed on the first substrate SUB1 between the second electrode EL2 and the common line CML. A voltage having, for example, an equipotential as the common voltage applied to the common electrode of the display panel DP is applied to the second electrode EL2.

The second alignment layer ALN2 is disposed on the second electrode EL2 to align the liquid crystal molecules of the liquid crystal layer LC. The second alignment layer ALN2 may include, for example, a polymer, such as, an organic polymer, e.g., polyimide. Other possible polymer which may be used to form the second alignment layer ALN2 include, for example, organic polymers such as polyamide, polyamide-imide, polyvinyl alcohol, epoxyacrylate, spiranacrylate, and polyurethane. The polymer may be, but is not limited to, a material having a glass transition temperature (Tg) equal to or less than about 200 degrees Celsius. For example, the polymer may include a material having a glass transition temperature (Tg) of equal to or less than about 160 degrees Celsius. The second alignment layer ALN2 is provided to have a pre-tilt angle of, for example, about 5 degrees.

The first retardation film AS_QWP is, for example, a quarter wavelength plate (QWP) to delay the phase of the light passing through the liquid crystal layer LC by about 214. The first retardation film AS_QWP is, for example, attached on the upper surface of the second base film BF2 by a first adhesive layer ADH1 provided on the upper surface of the second base film BF2.

A protective film PRT may be attached onto the first retardation film AS_QWP to protect the upper surface of the first retardation film AS_QWP. The protective film PRT is attached onto the first retardation film AS_QWP by, for example, a second adhesive ADH2 provided on the upper surface of the first retardation film AS_QWP. The protective film PRT and the second adhesive layer ADH2 may, for example, be removed after the active retarder AS is attached to the display panel DP.

The liquid crystal layer LC may include, for example, liquid crystal molecules of twisted nematic mode, which have a phase delay value of about 90 degrees, or liquid crystal molecules of electrically controlled birefringence (ECB) mode.

The sealing member SL is disposed between the first substrate SUB1 and the second substrate SUB2 along the edge of the second substrate SUB2 to seal a space between the first substrate SUB1 and the second substrate SUB2. The sealing member SL may include, for example, an ultraviolet-cured polymer.

In the active retarder AS having the above-mentioned structure, the first electrode EL1 and the second electrode EL2 form an electric field therebetween in response to a driving signal provided through the flexible printed circuit board FPC, and the liquid crystal layer LC adjusts the phase delay value of the light from the display panel DP in accordance with the electric field to control the polarization of the light passing therethrough. In this case, the driving signal is synchronized with the image of the display panel DP.

The display apparatus including the active retarder AS displays the 2D image or the 3D image in accordance with the selection by the user, which is provided through a user interface. Although not shown in figures, the user interface may be, but is not limited to, an on-screen display (OSD), a remote controller, a keyboard, a mouse, etc.

When the user selects the 2D image mode, the display panel DP provides, for example, the 2D image to the active retarder AS and the active retarder AS is turned off so as to transmit the image provided from the display panel DP. Thus, the user perceives the 2D image.

When the user selects the 3D image mode, the display panel DP provides, for example, the 2D image separated into the left-eye image and the right-eye image to the active retarder AS and the active retarder AS is turned on so as to polarize the left-eye image and the right-eye image in different directions from each other. Accordingly, the user watches the polarized left-eye image and the polarized right-eye image through the pair of polarizing glasses PG to perceive the 3D image.

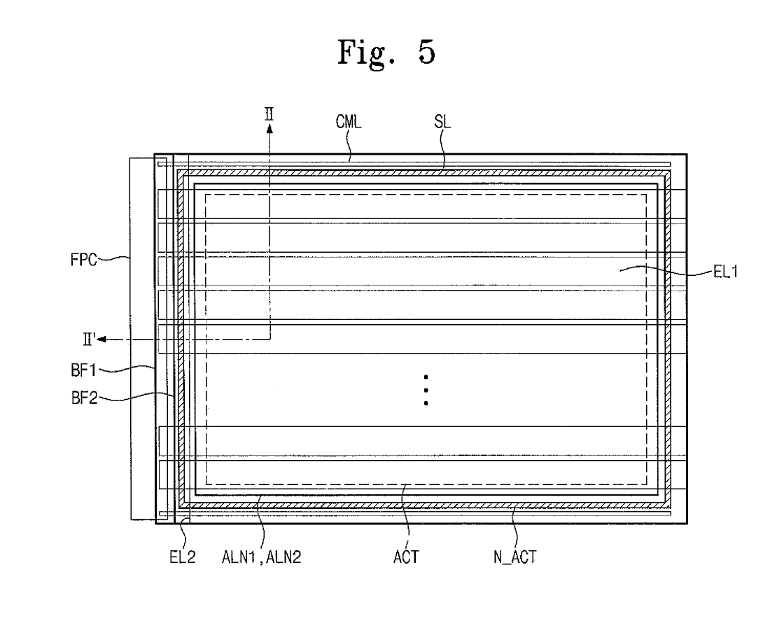

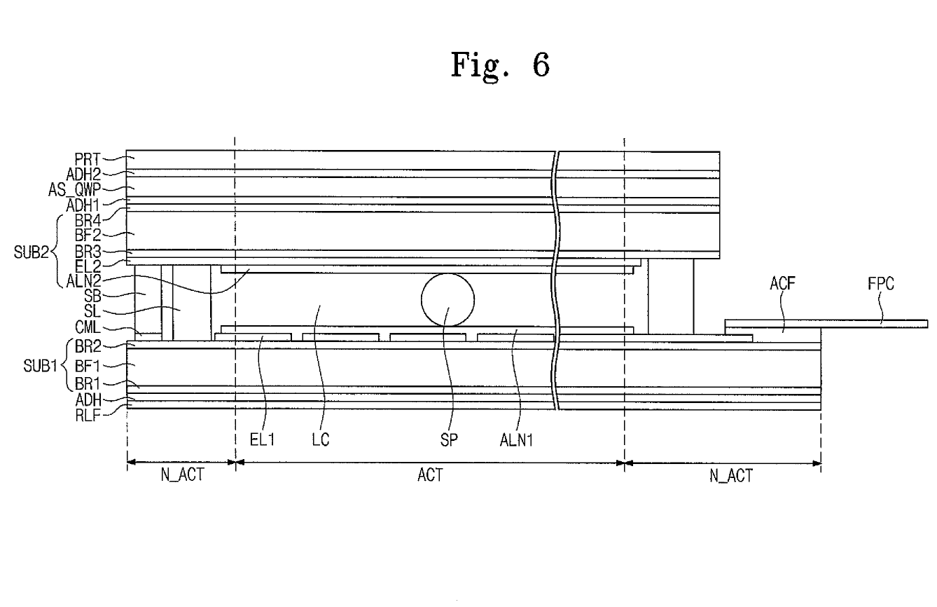

FIG. 5 is a plan view showing an active retarder according to an exemplary embodiment of the present invention and FIG. 6 is a cross-sectional view taken along a line II-II′ shown in FIG. 5. In FIGS. 5 and 6, the same reference numerals denote the same elements in FIGS. 1 to 4, and thus detailed descriptions of the same elements will be omitted.

Referring to FIGS. 5 and 6, the wire part is provided in the non-display area N_ACT to apply the voltage to the first electrode EL1 and the second electrode EL2. The wire part includes, for example, a flexible printed circuit board FPC transmitting the driving signal of the active retarder AS and a common line CML applying the reference voltage to the second electrode EL2. In the present exemplary embodiment, the connection line CNTL and the contact pad CNTP may be omitted from the wire part. The flexible printed circuit board FPC has, for example, substantially the same length as that of the corresponding side of the long sides or the short sides of the first base film BF1. The flexible printed circuit board FPC may make direct contact with the first electrode EL1 and the common line CML formed on the first substrate SUB1 through, for example, an anisotropic conductive film ACF. Alternatively, for example, in an embodiment, anisotropic conductive paste ACP or other anisotropic conductive adhesives ACA may be used in place of the anisotropic conductive film ACF. In the present exemplary embodiment, as the connection line CNTL and the contact pad CNTP are omitted, the processes required to form the connection line CNTL and the contact pad CNTP may be removed. As a result, a manufacturing process of the active retarder AS may be simplified and the manufacturing time of the active retarder AS may be shortened.

The second base film BF2 has, for example, a rectangular shape with a pair of long sides and a pair of short sides to correspond to the shape of the display panel DP. The second base film BF2 is, for example, smaller in size than the first base film BF1, and thus the portion of the upper surface corresponding to the non-display area N_ACT of the first base film BF1, in which the wire part is formed, is exposed. The exposed upper surface of the first base film BF1 corresponds to the area at which the flexible printed circuit board FPC is connected to the first electrode EL1 and the common line CML. In the present exemplary embodiment, as the fan-out part in which the connection lines CNTL is formed as shown in FIGS. 3 and 4 is omitted, the flexible printed circuit board FPC may be electrically connected to the first electrode EL1 and the common line CML by directly attaching the flexible printed circuit board FPC on the first electrode EL1 and the common line CML. In addition, the size of the exposed upper surface is narrower than that of the exposed upper surface described with reference to FIGS. 3 and 4.

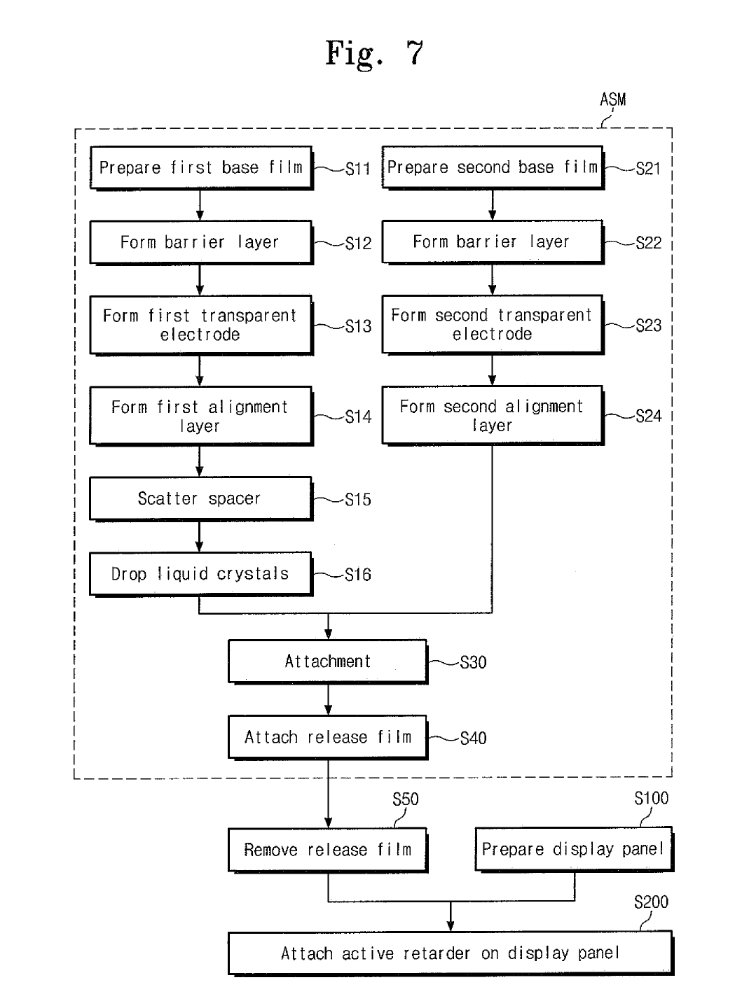

Hereinafter, a method of manufacturing an active retarder and a method of manufacturing the display apparatus in accordance with an exemplary embodiment of the present invention will be described with reference to FIGS. 1 to 6. FIG. 7 is a flowchart illustrating a method of manufacturing a display apparatus according to an exemplary embodiment of the present invention.

According to the method of manufacturing the display apparatus illustrated in FIG. 7, the display apparatus is manufactured by attaching the active retarder AS onto the display panel DP (S200) after the display panel DP and the active retarder AS are prepared ASM (S100). For the convenience of explanation, the method (ASM) of manufacturing the active retarder AS will be described.

The active retarder AS is formed by forming the first substrate SUB1 and the second substrate SUB2 and forming the liquid crystal layer LC between the first substrate SUB1 and the second substrate SUB2. The first substrate SUB1 and the second substrate SUB2 are formed, for example, by performing a roll-to-roll process.

The roll-to-roll process is a process of forming electronic parts on a roll of flexible substrate (e.g., a plastic substrate) or a thin metal substrate (e.g., a metal foil), and called a web process, a reel-to-reel process, or a R2R process. The roll-to-roll process means that coating, printing, and other processes are performed using the flexible substrate or the thin metal substrate, which is able to be rolled after the last process is finished.

In the method of the present exemplary embodiment illustrated in FIG. 7, the first substrate SUB1 is formed prior to the second substrate SUB2. However, it is not required that the first substrate SUB1 be formed prior to the second substrate SUB2 according to exemplary embodiments of the present invention. Alternatively, for example, in an embodiment, the second substrate SUB2 is formed prior to the first substrate SUB1.

The first substrate SUB1 is manufactured by, for example, preparing the first base film BF1 (S 11), forming a barrier layer on the first base film BF1 (S 12), forming the first electrode EL1 on the barrier layer (S13), and forming the first alignment layer ALN1 (S14).

The first base film BF1 has properties, such as, for example, transparency, flexibility, etc. To this end, the first base substrate BF1 may include, for example, a cyclic olefin polymer (COP) and/or triacetyl cellulose (TAC) so as to have the flexibility, but exemplary embodiments of the present invention are not be limited thereto or thereby. For example, the first base film BF1 may include at least one of polyethylene terephthalate, polycarbonate, polyetheretherketone, polyester, polyethylene naphthalate, polyethersulfone, polyimide, polyarylate, or polynorbornene. As the first base film BF1 has flexibility, the processes of forming thin films on the first base film BF1 may be performed using, for example, the roll-to-roll process. The roll-to-roll process is performed, for example, under a temperature equal to or less than the glass transition temperature of each material used for forming the first base film BF1. For example, the roll process may be performed under a temperature which is equal to or less than about 200 degrees Celsius (e.g., equal to or less than about 160 degrees Celsius).

The first and second barrier layers BR1 and BR2 are formed on the first base film BF1. The first barrier layer BR1 and the second barrier layer BR2 are disposed on, for example, both the upper and lower surfaces of the first base film BF1, respectively, using a wet coating process. The first barrier layer BR1 and the second barrier layer BR2 may be formed of, for example, an acrylic-based polymer. In the case that the first and second barrier layers BR1 and BR2 are formed of the acrylic-based polymer, the first and second barrier layers BR1 and BR2 may protect the first base film BF1 from being damaged by materials used to form the first alignment layer ALN1 and the second alignment layer ALN2. For example, when the first base film BF1 is coated by the first barrier layer BR1 and the second barrier layer BR2, although the first base film BF1 is exposed to the materials used to form the first and second alignment layers ALN1 and ALN2, such as acetone, gammabutyrolacetone (GBL), N-methylpyrrolidone (NMP), butylcellosolve (BC), isopropylalcohol (IPA), M-ethylpyrrolidone, N-vinylpyrrolidone, N,N-dimethylacetamide, N,N-dimethylformamide, ethylcellosolve, ethylcarbitol, butylcarbitol (BC), ethylcarbitol acetate, ethylene glycol, propylene glycol monoacetate, propylene glycol diacetate, dipropylene glycol, and dipropylene glycol monomethyl ether, during one hour or less, damages causing swelling or exfoliation on the other layers may not occur on the first base film BF1.

Then, the first electrode EL1 is formed on the second barrier layer BR2. The first electrode EL1 is formed by, for example, forming a first transparent conductive material on the first base film BF1 and patterning the first transparent conductive material. The first transparent conductive material may be, but is not limited to indium tin oxide (ITO), indium zinc oxide (IZO), and silver nanowire (AgNW), aluminum-doped zinc oxide (AZO), gallium-doped zinc oxide (GZO), fluorine-doped tin oxide (FTO), antimony-doped tin oxide (ATO), cadmium tin oxide (CTO), zirconium oxide (ZrO₂), zinc oxide (ZnO) and combinations thereof. The first transparent conductive material is formed using a process carried out under the glass transition temperature of the first transparent conductive material, such as, for example, a low-temperature plasma deposition process or a wet coating process. The first transparent conductive material formed on the first base film BF1 may be patterned by, for example, a laser trimmer. The common line CML of the wire part may be formed together with the first electrode EL1.

The first alignment layer ALN1 is formed on the first electrode EL1. The first alignment layer ALN1 is formed by, for example, forming an alignment layer using a material (e.g. an organic polymer having a glass transition temperature (Tg) equal to or less than about 200 degrees Celsius) mixed with a solvent, such as acetone, gammabutyrolacetone (GBL), N-methylpyrrolidone (NMP), butylcellosolve (BC), isopropylalcohol (IPA), N-ethylpyrrolidone, N-vinylpyrrolidone, N,N-dimethylacetamide, N,N-dimethylformamide, ethylcellosolve, ethylcarbitol, butylcarbitol (BC), ethylcarbitol acetate, ethylene glycol, propylene glycol monoacetate, propylene glycol diacetate, dipropylene glycol, and dipropylene glycol monomethyl ether, and rubbing the alignment layer.

The second substrate SUB2 is manufactured by, for example, preparing the second base film BF2 (S21), forming a barrier layer on the second base film BF2 (S22), forming the second electrode EL2 on the barrier layer (S23), and forming the second alignment layer ALN2 (S24). That is, the second substrate SUB2 is manufactured by, for example, similar processes to those of the first substrate SUB1.

The second base film BF2 has properties, such as, for example, transparency, flexibility, etc. To this end, the second base film BF2 may include a cyclic olefin polymer (COP) and/or triacetyl cellulose (TAC) so as to have the flexibility, but exemplary embodiments of the present invention are not limited thereto or thereby. For example, the second base film BF2 may include at least one of polyethylene terephthalate, polycarbonate, polyetheretherketone, polyester, polyethylene naphthalate, polyethersulfone, polyimide, polyarylate, or polynorbornene. As the second base film BF2 is flexible like the first base film BF1, the processes of forming thin films on the second base film BF2 may be performed using, for example, the roll-to-roll process. The roll-to-roll process is performed under a temperature equal to or less than the glass transition temperature of each material used for forming the second base film BF2. For example, the roll-to-roll process may be performed under a temperature which is equal to or less than about 200 degrees Celsius, (e.g., equal to or less than about 160 degrees Celsius).

The third and fourth barrier layers BR3 and BR4 are formed on the second base film BF2. The third barrier layer BR3 and the fourth barrier layer BR4 are disposed on, for example, both the upper and lower surfaces of the second base film 13F2, respectively, using a wet coating process. The third barrier layer BR3 and the fourth barrier layer BR4 may be formed of, for example, an acrylic-based polymer. In the case that the third and fourth barrier layers BR3 and BR4 are formed of an acrylic-based polymer, the third and fourth barrier layers BR3 and BR4 may protect the second base film BF2 from being damaged by materials used to form the first alignment layer ALN1 and the second alignment layer ALN2. For instance, when the second base film BF2 is coated by the third barrier layer BR3 and the fourth barrier layer BR4, although the second base film BF2 is exposed to the materials used to form the first and second alignment layers ALN1 and ALN2, such as acetone, gammabutyrolacetone (GBL), N-methylpyrrolidone (NMP), butylcellosolve (BC), isopropylalcohol (IPA), M-ethylpyrrolidone, N-vinylpyrrolidone, N,N-dimethylacetamide, N,N-dimethylformamide, ethylcellosolve, ethylcarbitol, butylcarbitol (BC), ethylcarbitol acetate, ethylene glycol, propylene glycol monoacetate, propylene glycol diacetate, dipropylene glycol, and dipropylene glycol monomethyl ether, during one hour or less, damages causing swelling or exfoliation on the other layers may not occur on the first base film BF1.

The second electrode EL2 is formed on the third barrier layer BR3. The second electrode EL2 is formed by, for example, forming a second transparent conductive material on the second base film BF2 and patterning the second transparent conductive material. The second transparent conductive material may be, but is not limited to indium tin oxide (ITO), indium zinc oxide (IZO), silver nanowire (AgNW), aluminum-doped zinc oxide (AZO), gallium-doped zinc oxide (GZO), fluorine-doped tin oxide (FTO), antimony-doped tin oxide (ATO), cadmium tin oxide (CTO), zirconium oxide (ZrO₂), zinc oxide (ZnO) and combinations thereof. The second transparent conductive material is formed using a process carried out under the glass transition temperature of the second transparent conductive material, such as, for example, a low-temperature plasma deposition process or a wet coating process. The second transparent conductive material formed on the second base film BF2 is formed, for example, in a single, e.g., a single plate-like shape.

The second alignment layer ALN2 is formed on the second electrode EL2. The second alignment layer ALN2 is formed by, for example, forming an alignment layer using a material (e.g. an organic polymer having a glass transition temperature (Tg) equal to or less than about 200 degrees Celsius) mixed with a solvent, such as acetone, gammabutyrolacetone (GBL), N-methylpyrrolidone (NMP), butylcellosolve (BC), isopropylalcohol (IPA), N-ethylpyrrolidone, N-vinylpyrrolidone, N,N-dimethylacetamide, N,N-dimethylformamide, ethylcellosolve, ethylcarbitol, butylcarbitol (BC), ethylcarbitol acetate, ethylene glycol, propylene glycol monoacetate, propylene glycol diacetate, dipropylene glycol, and dipropylene glycol monomethyl ether, and rubbing the alignment layer.

Meanwhile, the first retardation film AS_QWP is attached onto the fourth barrier layer BR4 using, for example, the first adhesive layer ADH1. The protective film PRT may be attached onto the first retardation film AS_QWP using, for example, the second adhesive layer ADH2. Different from the above, the first retardation film AS_QWP and the protective film PRT may be formed, for example, before the second electrode EL2 and the second alignment layer ALN2 are formed. That is, the second electrode EL2 and the second alignment layer ALN2 may be formed after sequentially attaching the first retardation film AS_QWP and the protective film PRT on the fourth barrier layer BR4.

Then, the wire part is formed on the first base film BF1. In the present exemplary embodiment, the wire part is formed after the first alignment layer ALN1 is formed, but exemplary embodiments of the present invention are not limited thereto or thereby. For example, the wire part may be formed before the first alignment layer ALN1 is formed but after the first electrode EL1 is formed. The connection line CNTL and the contact pad CNTP of the wire part may be readily formed by, for example, using a printing method of a conductive material. However, the method of forming the connection line CNTL and the contact pad CNTP is not limited to the printing method, and the wire part may be formed by, for example, forming a metal layer using a process performed under the glass transition temperature, such as a low-temperature plasma deposition process or a wet coating process, and patterning the metal layer.

After forming the connection line CNTL and the contact pad CNTP, the flexible printed circuit board FPC is attached onto the connection line CNTL using, for example, an anisotropic conductive film ACF. According to an embodiment in which the connection line CNTL and the contact pad CNTP are not formed, the flexible printed circuit board FPC is directly attached to the first electrode EL1 and the common line CML using the anisotropic conductive film ACF without forming the connection line CNTL and the contact pad CNTP. Alternatively, for example, in an embodiment, anisotropic conductive paste ACP or other anisotropic conductive adhesives ACA may be used in place of the anisotropic conductive film ACF.

After that, the liquid crystal layer LC is formed between the first substrate SUB1 and the second substrate SUB2. The liquid crystal layer LC is formed by, for example, forming a spacer SP on the first substrate SUB1 (S15), dropping the liquid crystal (S16), and coupling the first substrate SUB1 and the second substrate SUB2 to each other (S30).

The spacer SP is formed by, for example, scattering beads on the first substrate SUB1. In the present exemplary embodiment, the beads are scattered on the first substrate SUB1, but exemplary embodiments of the present invention are not limited to scattering the beads on the first substrate SUB1. That is, the beads may alternatively be scattered on, for example, the second substrate SUB2 or on both of the first and second substrates SUB1 and SUB2. In addition, the spacer SP may be formed on the first substrate SUB1 by using, for example, a gravure printing method.

A sealant is formed on the first substrate SUB1 along, for example, the periphery of the display area ACT. The sealant is formed of, for example, a light-curing material, e.g., an ultraviolet-cured polymer.

The shorting bar SB is formed on the common line CML using, for example, a conductive material. The shorting bar SB may be formed using, for example, a silver (Ag) dotting method.

The liquid crystal is, for example, dropped on the first substrate SUB1 on which the sealant is formed (S16).

Then, the second substrate SUB2 is disposed on the first substrate SUB1 and the light e.g., an ultraviolet ray, is irradiated onto the sealant to cure the sealant. The sealant is cured to form the sealing member SL, and thus the first substrate SUB1 and the second substrate SUB2 are coupled to each other (S30). When the first substrate SU1 and the second substrate SUB2 are coupled to each other, the common line CML and the second electrode EL2 are connected to each other through the shorting bar SB. The liquid crystal is positioned inside the space defined by the first and second substrate SUB1 and SUB2 and the sealing member SL.

Each of the spacer SP, the sealant, the shorting bar SB, and the liquid crystal may be formed on one of the first substrate SUB1 and the second substrate SUB2. In the present exemplary embodiment, the spacer SP, the sealant, the shorting bar SB, and the liquid crystal are formed on the first substrate SUB1 as an example.

Meanwhile, for example, the adhesive layer ADH is formed on the first barrier layer BR1 formed on the lower surface of the first substrate SUB1 and the release film RLF is attached to the first barrier layer BR1 using the adhesive layer ADH disposed between the release film RLF and the first barrier layer BR1 (S40). The release film RLF may be attached to the first barrier layer BR1 after the first substrate SUB1 and the second substrate SUB2 are coupled to each other, but exemplary embodiments of the present invention are not limited thereto or thereby. For instance, the release film RLF may be attached on the first barrier layer BR1 using the adhesive layer ADH before the first electrode EL1 or the first alignment layer ALN1 is formed on the first base film BF1, and then the first electrode EL1 or the first alignment layer ALN1 is formed on the second barrier layer BR2.

The active retarder AS manufactured by the above-described method is attached to the display panel DP (S200). For example, before attaching the active retarder AS to the display panel DP, the release film RLF attached to the first substrate SUB1 of the active retarder AS is removed (S50). The adhesive layer ADH exposed by the removal of the release film RLF is pressed to the display panel DP using, for example, a roller to make contact with the display panel DP. As the active retarder AS has flexibility, the active retarder AS may be attached to the display panel DP by using, for example, the roll-to-roll process.

In the manufacturing process of the display apparatus according to an exemplary embodiment of the present invention, not only the first and second base films but also all elements formed on or attached to the first and second base films may have flexibility. Thus, the processes of forming the first substrate, forming the second substrate, coupling the first and second substrates, and attaching the active retarder to the display panel may be simply performed using, for example, the roll-to-roll process. As a result, the manufacturing process of the display apparatus is simplified and the manufacturing cost and time of the display apparatus may be reduced. In addition, as the flexible substrate formed of the polymer is used instead of a glass substrate, the manufacturing cost of the active retarder and the display apparatus including the active retarder is reduced.

For instance, the active retarder includes the electrodes respectively formed on the base films to face each other, but exemplary embodiments of the present invention are not limited thereto or thereby. That is, the electrodes may be formed, for example, on only one of the base films. In addition, as the liquid crystals of the liquid crystal layer may depend on the structure of the electrodes, various liquid crystals, such as cholesteric liquid crystals, blue-phase liquid crystals, may be used in the liquid crystal layer.

Having described exemplary embodiments of the present invention, it is further noted that it is readily apparent to those of ordinary skill in the art that various modifications may be made without departing from the spirit and scope of the invention which is defined by the metes and bounds of the appended claims.

What is claimed is:

1. A method of manufacturing an active retarder for a display apparatus, comprising:
forming a first substrate;
forming a second substrate; and
forming a liquid crystal layer between the first substrate and the second substrate, wherein the forming of the first and second substrates is performed by a roll-to-roll process.

2. The method of claim 1, wherein the forming of the first substrate comprises:
preparing a first base film;
forming a first transparent conductive material on the first base film; and
patterning the first transparent conductive material to form a first electrode on the first base film, and wherein the forming of the second substrate comprises:
preparing a second base film; and
forming a second transparent conductive material on the second base film to form a second electrode on the second base film.

3. The method of claim 2, wherein the first transparent conductive material and the second transparent conductive material are coated by a wet process.

4. The method of claim 2, wherein each of the first transparent conductive material and the second transparent conductive comprises at least one of indium tin oxide (ITO), indium zinc oxide (IZO), or silver nanowire (AgNW).

5. The method of claim 4, wherein the first transparent conductive material is patterned by a laser etching process.

6. The method of claim 2, wherein the forming of the liquid crystal layer comprises:
forming a spacer on the first substrate;
forming a sealant on the first substrate;
dropping a liquid crystal on the first substrate;
positioning the second substrate to face the first substrate; and
curing the sealant.

7. The method of claim 6, wherein the spacer is formed by scattering beads on the first substrate.

8. The method of claim 6, wherein the spacer is formed by a gravure printing method.

9. The method of claim 6, wherein the sealant is cured by an ultraviolet ray.

10. The method of claim 2, further comprising forming a plurality of barrier layers on an upper surface and a lower surface of the first base film and on an upper surface and a lower surface of the second base film, respectively.

11. The method of claim 2, wherein the forming of the first substrate comprises:
forming a first alignment layer on the first electrode, and
rubbing the first alignment layer, and wherein the forming of the second substrate comprises:
forming a second alignment layer on the second electrode, and
rubbing the second alignment layer.

12. The method of claim 2, further comprising forming a wire part on the first substrate which connects the first and second electrodes to each other.

13. The method of claim 12, wherein the wire part is formed by printing a metal layer.

14. The method of claim 1, wherein each of the first substrate and the second substrate is a flexible substrate and the roll-to-roll process is performed under a temperature of about 160 degrees Celsius.

15. A method of manufacturing a display apparatus, comprising:
preparing a display panel; and
attaching an active retarder manufactured by a method according to claim 1 to the display panel.

16. The method of claim 15, wherein the attaching of the active retarder comprises:
attaching a release film on a surface of the active retarder while interposing an adhesive layer between the release film and the active retarder; and
removing the release film to attach the active retarder to the display panel.

17. The method of claim 16, wherein the active retarder is attached on the display panel by:
positioning the active retarder on the display panel; and
applying a pressure on the active retarder toward the display panel using a roller.

18. A method of manufacturing an active retarder for a display apparatus, comprising:
forming a first flexible substrate, wherein the forming of the first flexible substrate comprises:
preparing a first base film,
forming a first barrier layer on an upper surface of the first base film,
forming a first electrode on the first barrier layer, and
forming a first alignment layer on the first electrode; and
forming a second flexible substrate, wherein the forming of the second flexible substrate comprises:
preparing a second base film,
forming a second barrier layer on an upper surface of the second base film,
forming a second electrode on the second barrier layer,
forming a second alignment layer on the second electrode;
attaching a first retardation film on an upper surface of the second barrier layer using a first adhesive layer provided on the upper surface of the second barrier layer;
attaching a protective film onto an upper surface of the first retardation film using a second adhesive layer provided on the upper surface of the first retardation film;
providing liquid crystals on one of the first flexible substrate or the second flexible substrate; and
attaching the first flexible substrate and the second flexible substrate to each other with a liquid crystal layer disposed therebetween.

19. The method of claim 18, wherein the forming of the first and second flexible substrates is performed by a roll-to-roll process.

20. The method of claim 18, further comprising forming a wire part on the first base film which connects the first and second transparent electrodes to each other.

21. The method of claim 20, wherein the wire part includes a flexible printed circuit board and a common line, wherein the flexible printed circuit board is electrically connected to first electrode and the common line and wherein the flexible printed circuit board directly contacts the first electrode and the common line via an anisotropic conductive film.

22. The method of claim 21, wherein the second base film is smaller in size than the first base film and wherein a portion of the wire part formed on the first base film is exposed by the second base film.

23. The method of claim 20, wherein the wire part includes a flexible printed circuit board, a connection line connected to the flexible printed circuit board though an anisotropic conductive film, a common line connected to the connection line and configured to apply a reference voltage to the second electrode and a contact pad connected to the connection line and which directly contacts with the first electrode and the common line.

24. The method of claim 18, wherein the first and second alignment layers are formed by mixing an organic polymer having a glass transition temperature of no greater than about 200 degrees Celsius with a solvent.

25. The method of claim 24, wherein the solvent is selected from the group consisting of acetone, gammabutyrolacetone (GBL), N-methylpyrrolidone (NMP), butylcellosolve (BC), and isopropylalcohol (IPA).

26. The method of claim 18, wherein the first and second base films are each formed of a material selected from the group consisting of polyethylene terephthalate, polycarbonate, and polyetheretherketone.
